(19) United States
(12) Patent Application Publication
(10) Pub. No.: US 2017/0192933 A1
(43) Pub. Date: Jul. 6, 2017

(54) CIRCUITS, DEVICES, AND METHODS FOR TRANSMITTING DATA IN A SERIAL BUS

(71) Applicant: SKYWORKS SOLUTIONS, INC., Woburn, MA (US)

(72) Inventors: Matthew Lee BANOWETZ, Marion, IA (US); James Henry Ross, Cedar Rapids, IA (US)

(21) Appl. No.: 15/394,598

(22) Filed: Dec. 29, 2016

Related U.S. Application Data
(60) Provisional application No. 62/274,125, filed on Dec. 31, 2015.

(51) Int. Cl. G06F 13/42; G06F 13/364

(52) U.S. Cl. CPC G06F 13/4291; G06F 13/364

(57) ABSTRACT

Circuits, devices, and method for transmitting data in a serial bus. In some embodiments, the radio-frequency module includes a serial data line configured to communicate data serially. The radio-frequency module also includes a first signal line configured to indicate that new data is available for transmission via the serial data line. The radio frequency module further includes a first device coupled to the serial data line and the first signal line, the first device configured to transmit first data to a second device via the serial data line, transmit a first signal via the first signal line indicating to the second device that the new data is available, and transmit the new data to the second device via the serial data line.

### CROSS-REFERENCE TO RELATED APPLICATION(S)

This application claims priority to U.S. Provisional Patent Application No. 62/274,125 filed Dec. 31, 2015, entitled CIRCUITS, DEVICES, AND METHODS FOR TRANSMITTING DATA IN A SERIAL BUS. The contents of each of the above-referenced application(s) are hereby expressly incorporated by reference herein in their entireties for all purposes.

### BACKGROUND

Field

The present disclosure relates to modules for radio-frequency (RF) applications.

Description of Related Art

Many electronic devices include circuits, devices, components, and/or modules configured to provide wireless functionality (e.g., wireless local area network (WLAN) or cellular functionality). Such a wireless functionality allows an electronic device to communicate with one or more other devices in a wireless manner. The circuits, devices, components, and/or modules may be included in a module such as a front-end module (FEM).

### SUMMARY

In some implementations, the present disclosure relates to a radio-frequency (RF) module. The radio-frequency module includes a serial data line configured to communicate data serially. The radio-frequency module also includes a first signal line configured to indicate that new data is available for transmission via the serial data line. The radio frequency module further includes a first device coupled to the serial data line and the first signal line, the first device configured to transmit first data to a second device via the serial data line, transmit a first signal via the first signal line indicating to the second device that the new data is available, and transmit the new data to the second device via the serial data line.

In some embodiments, the new data is received during transmission of the first data.

In some embodiments, the new data is transmitted prior to completion of transmission the first data.

In some embodiments, the first data is included in a first frame.

In some embodiments, the new data is transmitted without completing transmission of the first frame.

In some embodiments, the first device is further configured to determine that the new data is available for transmission via the serial data line.

In some embodiments, the radio-frequency module further includes a second signal line configured receive a second signal indicating to the first device that the new data is available for transmission to the second device via the serial data line.

In some embodiments, the first device is determines that the new data is available for transmission based on the second signal.

In some embodiments, the first device is further configured to alternate the first signal between a first state and a second state each time new data is available for transmission.

In some embodiments, the first device is configured to maintain the first signal at a first state when new data is available for transmission.

In some embodiments, the radio-frequency module further includes the second device.

In some embodiments, the second device is separate from the RF module.

In some embodiments, the radio-frequency module further includes a clock line configured to transmit a clock signal.

In some embodiments, the first device is configured to transmit the first data based on the clock signal.

In some embodiments, the first device is configured to transmit the new data based on the clock signal.

In some implementations, the present disclosure relates to radio-frequency (RF) module. The radio-frequency module includes a serial data line configured to communicate data serially. The radio-frequency module also includes a first signal line configured to indicate that new data is available for receiving via the serial data line. The radio-frequency module further includes a first device coupled to the serial data line and the first signal line, the first device configured to receive first data from a second device via the serial data line, receive a first signal via the first signal line indicating to the first device that the new data is available, and receive the new data from the second device via the serial data line.

In some embodiments, the new data is received during receipt of the first data.

In some embodiments, the new data is transmitted prior to completion of receipt the first data.

In some embodiments, the first data is included in a first frame.

In some embodiments, the new data is received without completing receipt of the first frame.

In some embodiments, the first signal transitions between a first state and a second state each time new data is available for transmission.

In some embodiments, the first device is further configured to process data received a time period after a last transition between the first state and the second state.

In some embodiments, the first signal remains in a first state when new data is available for transmission and transitions to a second state when no new data is available for transmission.

In some embodiments, the first device is further configured to process data received a time period before the first signal transitions to the second state.

In some embodiments, the radio-frequency module further includes the second device.

In some embodiments, the second device is separate from the RF module.

In some embodiments, the radio-frequency module further includes a clock line configured to transmit a clock signal.

In some embodiments, the first device is configured to receive the first data based on the clock signal.

In some embodiments, the first device is configured to receive the new data based on the clock signal.

In some implementations, the present disclosure relates to a method. The method includes transmitting first data to a device via a serial data line. The method also includes determining that new data is available to transmit to the device. The method further includes transmit a first signal via a first signal indicating to the device that the new data is available. The method further includes transmitting the new data to the device via the serial data line.

In some embodiments, wherein the new data is received during transmission of the first data.

In some embodiments, the new data is received prior to completion of transmission the first data.

In some embodiments, the first data is included in a first frame.

In some embodiments, the new data is transmitted without completing transmission of the first frame.

In some embodiments, determining that new data is available comprises receiving a second signal via a second line indicating that the new data is to be transmitted to the device.

In some embodiments, the method further includes alternating the first signal between a first state and a second state each time new data is available for transmission.

In some embodiments, the method further includes maintaining the first signal at a first state when new data is available for transmission.

In some implementations, the present discloser relates to a method. The method includes receiving first data from a device via a serial data line. The method also includes receiving a first signal via a first signal line indicating that new data is available. The method further includes receiving the new data from the device via the serial data line.

In some embodiments, the new data is received during receipt of the first data.

In some embodiments, the new data is received prior to completion of receipt the first data.

In some embodiments, the first data is included in a first frame.

In some embodiments, the new data is received without completing receipt of the first frame.

In some embodiments, the first signal alternates between a first state and a second state each time new data is available for transmission.

In some embodiments, the method further includes processing the new data received during a time period after a last transition between the first state and the second state.

In some embodiments, the first signal remains in a first state when new data is available for transmission and transitions to a second state when no new data is available for transmission.

In some embodiments, the method further includes processing data received during a time period before the first signal transitions to the second state.

In some implementations, the present disclosure relates to a non-transitory computer readable storage medium comprising instructions that, when executed by a processor, cause the processor to perform operations. The operations include transmitting first data to a device via a serial data line. The operations also include determining that new data is available to transmit to the device. The operations further include transmitting a first signal via a first signal indicating to the device that the new data is available. The operations further include transmitting the new data to the device via the serial data line.

In some implementations, the present disclosure relates to a non-transitory computer readable storage medium comprising instructions that, when executed by a processor, cause the processor to perform operations. The operations include receiving first data from a device via a serial data line. The operations also include receiving a first signal via a first signal line indicating that new data is available. The operations further include receiving the new data from the device via the serial data line.

In some implementations, the present disclosure relates to an electronic device. The electronic device includes a radio-frequency (RF) module including a serial data line configured to communicate data serially, a first signal line configured to indicate that new data is available for transmission via the serial data line, and a first device coupled to the serial data line and the first signal line, the first device configured to transmit first data to a second device via the serial data line, transmit a first signal via the first signal line indicating to the second device that the new data is available, and transmit the new data to the second device via the serial data line.

In some implementations, the present disclosure relates to an electronic device. The electronic device includes a radio-frequency (RF) module including a serial data line configured to communicate data serially, a first signal line configured to indicate that new data is available for receiving via the serial data line, and a first device coupled to the serial data line and the first signal line, the first device configured to receive first data from a second device via the serial data line, receive a first signal via the first signal line indicating to the first device that the new data is available, and receive the new data from the second device via the serial data line.

### BRIEF DESCRIPTION OF THE DRAWINGS

FIG. 1 is a block diagram of device/components coupled together via a serial bus/interface, according to some embodiments of the present disclosure.

FIG. 2A is a block diagram illustrating a RF module 200 and a RF module 201, according to some embodiments of the present disclosure.

FIG. 2B is a block diagram illustrating an example RF module 202, according to some embodiments of the present disclosure.

FIG. 3 is a timing diagraming illustrating example data that may be communicated with a serial bus/interface, according to some embodiments of the present disclosure.

FIG. 4A is a timing diagraming illustrating example data that may be communicated with a serial bus/interface, according to some embodiments of the present disclosure.

FIG. 4B is a timing diagraming illustrating an example data that may be communicated with a serial bus/interface, according to some embodiments of the present disclosure.

FIG. 4C is a timing diagraming illustrating an example data that may be communicated with a serial bus/interface, according to some embodiments of the present disclosure.

FIG. 5 is a block diagram illustrating an example module, according to some embodiments of the present disclosure.

FIG. 6 is a block diagram illustrating an example wireless device, according to some embodiments of the present disclosure.

FIG. 7 is a flow diagram illustrating a process for transmitting data via a serial bus, according to some embodiments of the present disclosure.

FIG. 8 is a flow diagram illustrating a process for receiving data via a serial bus, according to some embodiments of the present disclosure.

### DETAILED DESCRIPTION OF SOME EMBODIMENTS

The headings provided herein, if any, are for convenience only and do not necessarily affect the scope or meaning of the claimed invention.

Disclosed are non-limiting examples of systems, devices, circuits and/or methods related to techniques for transmitting data in a serial bus. Although the present disclosure may be described in the context of a serial bus/interface, it will be understood that one or more features of the present disclosure may also be utilized in other applications. For example, the examples, embodiments, implementations, and/or features described herein may be utilized with an RF front-end (RFFE) bus, an Inter-Integrated Circuit (I2C) bus, and/or other types of serial buses/interfaces.

Many wireless communication devices (e.g., a cellular handset system) use a serial bus to communicate between modules and/or components of the wireless communication devices. The use of serial buses in these wireless communication devices may allow for increased complexity of the radio-frequency (RF) front-end components and the configuration of the RF front-end (RFFE) components used in the wireless communication devices. For example, multiple configuration modes, detailed feedback, and timing synchronization may be accomplished using interface signals shared amongst multiple RF devices/components. Examples of the devices/components on that may use a serial bus may include, but are not limited to, a power amplifier (PA), a RF power supply management component/module, an antenna switch, and an antenna tuner.

Many devices, modules, and/or components use a serial interface to reduce the number of package pins (e.g., lines, control lines, data lines, signal lines, etc.) and associated board-level routing. For example, an RF device component and/or module may generally use two signals to communicate data, a clock signal and a data signal, as discussed in more detail below. A serial interface may increase latency in transmitting, receiving, and/or processing data (e.g., commands). For example, in order to transmit a data (e.g., data such as a command, a frame, a message, etc.) that is eight bits long, a RF device, module, and/or component may use multiple clock cycles (e.g., eight clock cycles) to transmit the data. An RF device, module, and/or component may not be able to begin transmitting additional data (e.g., new data) until the previous data has been completely transmitted, due to the serial nature of the serial interface.

Described herein are examples of transmitting new data on a serial interface/bus, such as the RFFE interface/bus (e.g., a Mobile Industry Processor Interface (MIPI) RFFE interface/bus). In one embodiment, a signal line is used by a transmitting device (e.g., a device transmitting data) to indicate to a receiving device (e.g., a device receiving data) that new data is available. The signal line may allow the transmitting device to transmit new data to the receiving device without completely transmitting the previous data (e.g., the old data).

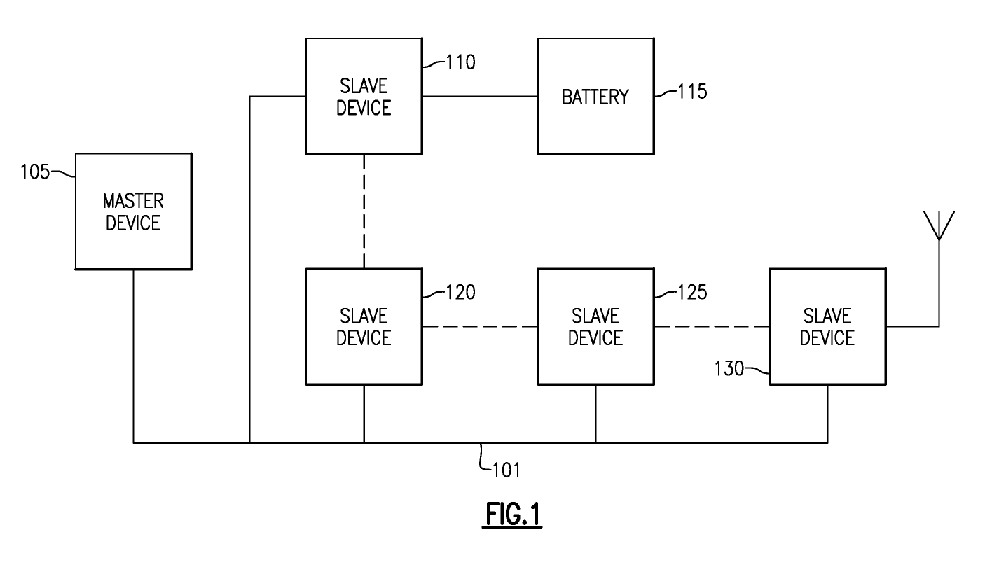

FIG. 1 is a block diagram of device/components (e.g., RF devices/components) coupled together via a serial bus/interface (e.g., an RFFE bus/interface), according to some embodiments of the present disclosure. The master device 105, the slave devices 110, 120, 125, and 130, and the serial bus 101 may be part of an RF front end. The serial bus 101 may include one or more lines (e.g., pins, data lines, signal lines, clock lines, etc.), as discuss in more detail below. The master device 105 device/component may control the configuration and/or operation of the slave devices 110, 120, 125, and 130 coupled to the serial bus 101. For example, the master device 105 device/component may control the configuration and/or operation of one or more of the slave device 110, slave device 120, slave device 125, and slave device 130. As illustrated in FIG. 1, the master device 105, slave device 110, slave device 120, slave device 125 and slave device 130 are coupled to each other via the serial bus 101. In one embodiment, one or more of the slave devices may also be coupled to each other separate from the serial bus 101. For example, slave device 110 is coupled to slave device. In another example, slave device 120 is coupled to slave device 125. In a further example, slave device 125 is coupled to slave device 130. The slave device 110 is coupled to a battery 115. The master device 105 may be referred to as a master module, a master component, a master, etc. The slave devices 110, 120, 125, and 130 may be referred to as slave slaves modules, slave components, slaves, etc.

The master device 105 may transmit data such as messages, commands, packets, frames etc., to the slave devices 110, 120, 125, and 130 to control the operation of the slave devices and/or to configure each slave device. For example, the master device 105 may transmit one or more messages (e.g., configuration messages or messages with data indicating how a slave device/component should operate or be configured) to the slave device 120. In another example, the master device 105 may transmit a command (e.g., RFFE commands such as a read command, a write command, an extended read command, an extended write command, etc.) to the slave device 125. When a slave device receives the command, the slave device may perform one or more operations based on the command. For example, the slave device 110 may read data from a memory address, write data to a memory address, modify a configuration of the slave device 110, etc., based on the command received from the master device 105.

Although the present disclosure may refer to an RFFE bus/interface (e.g., a MIPI RFFE bus/interface), on one having ordinary skill in the art understands that the examples, embodiments, and/or implementations described herein may be applied to other types of buses/interfaces. The examples, embodiments, and/or implementations may be applied other types of serial interfaces such as an I2C bus/interface, a serial peripheral interface (SPI), etc.

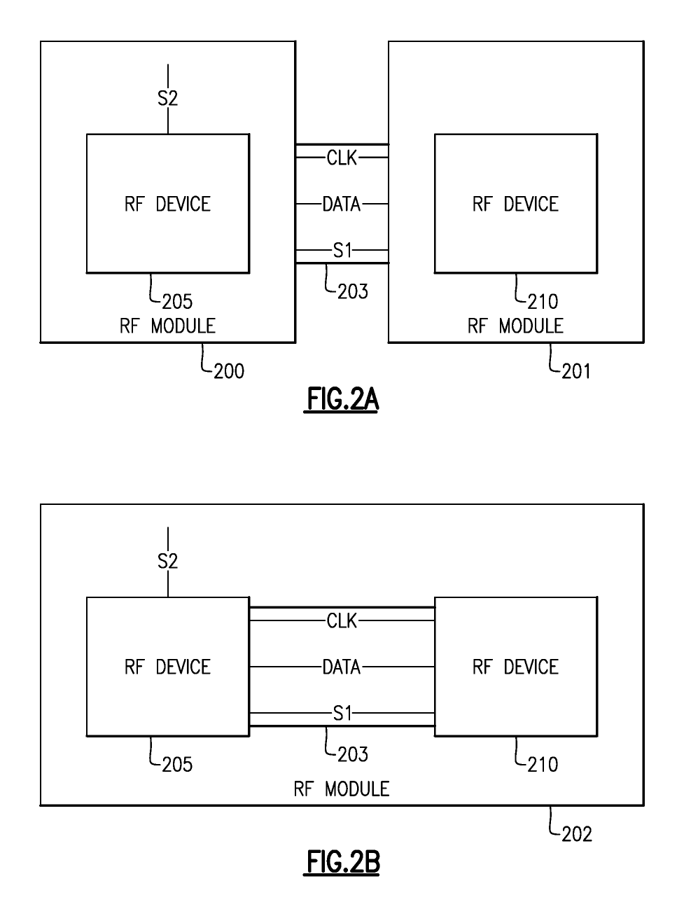

FIG. 2A is a block diagram illustrating a RF module 200 and a RF module 201, according to some embodiments of the present disclosure. RF module 200 includes an RF device 205 and RF module 201 includes RF device 210. As illustrated in FIG. 2A, the RF device 205 and the RF device 210 are located in separate RF modules. In one embodiment, the RF module 200 may be coupled to the RF module 201 via a serial bus 203 (e.g., an RFFE bus). The serial bus 203 may include multiple lines (e.g., multiple pins, multiple traces, etc.) that may communicate (e.g., transmit and/or receive) signals and/or data between the RF module 200 and the RF module 201. The RF device 205 and RF device 210 may use the serial bus 203 to communicate signals and/or serial data. As illustrated in FIG. 2A, the serial bus 203 includes a DATA line that may transmit serial data (e.g., messages, commands, frames, packets, bits, etc.) between the RF module 200 and the RF module 201. For example, the DATA line may communicate data one bit at a time (e.g., may communicate data serially or sequentially). The serial bus 203 also includes an S1 line that may indicate when new data is available. The serial bus 203 further includes a CLK line that may transmit a clock signal between the RF module 200 and the RF module 201. The RF device 205 and the RF device 210 may use the clock signal and/or the CLK line to control the timing of the serial bus 203. For example, the serial bus 203 may operate at the frequency of the clock signal (e.g., the DATA line may be synchronized with the clock signal). The S2 line may transmit a signal to the RF device 205 to indicate that the RF device 205 should transmit new data to the RF device 210. The new data may be received from another RF module and/or another RF device in the RF module 200.

In one embodiment, the RF device 205 may transmit first data to the RF device 210 via the DATA line. The RF device 205 may determine whether new data is available to communicate (e.g., transmit) to the RF device 210. For example, the RF device 205 may determine whether data and/or a signal was received via the S2 line indicating (to the RF device 205) that the RF device 205 should transmit new data to the RF device 210. The RF device 205 may transmit a signal and/or data to the RF device 210 (via the S1 line) to indicate (to the RF device 210) that the RF device 205 is transmitting new data to the RF device 210.

In one embodiment, the RF device 205 may receive the new data while the RF device 205 is in the process of transmitting the first data and/or while the RF device 210 is in the process of receiving the first data. For example, the RF device 205 may receive the new data before the RF device has completed transmission of the first data and before the RF device 210 has completely received the first data. In another example, the first data may be included in a frame (e.g., a message, a packet, etc.). The RF device 205 may receive the new data before the RF device 250 completes transmission of the frame and/or before the RF device 210 completely receives the frame. The RF device 205 may transmit data and/or a first signal via the S1 line to indicate to the RF device 210 that the RF device 205 is transmitting new data to the RF device 210, as discussed in more detail below.

In another embodiment, the RF device 205 may begin transmitting the new data to the RF device 205 without completely transmitting the first data to the RF device 210 and/or before the RF device 210 completely receives first data. For example, the RF device 250 may begin transmitting a new frame (with the new data) before completely transmitting the previous frame (with the first data) and the RF device 210 may begin receiving the new frame without completely receiving the previous frame (as discussed in more detail below).

In one embodiment, the RF device 205 may maintain the first signal (transmitted via the S1 line) at a logical high state (e.g., a “1” state) when the RF device 205 is transmitting new data to the RF device 210. The RF device 205 may change the first signal to a logical low state (e.g., a “0” state) when the RF device 205 completes transmission of the new data. The RF device 210 may use the new data received during a time period before the first signal transitions to the logical low state, as discussed in more detail below.

In another embodiment, the RF device 205 may alternate the first signal between the logical high state and the logical low state each time new data is available for transmission to the RF device 210. The RF device 210 may use the new data received during a time period after the last time the first signal alternated between the logical high state and the logical low state, as discussed in more detail below.

FIG. 2B is a block diagram illustrating an example RF module 202, according to some embodiments of the present disclosure. RF module 202 includes the RF device 205 and the RF device 210. The RF device 205 may be coupled to the RF device 210 via a serial bus 203 (e.g., an RFFE bus). The serial bus 203 may include multiple lines (e.g., multiple pins, multiple traces, etc.) that may communicate (e.g., transmit and/or receive) signals and/or data between the RF module 200 and the RF module 201, as discussed above. The RF device 205 and RF device 210 may use the serial bus 203 to communicate signals and/or serial data, as discussed above. As illustrated in FIG. 2B, the serial bus 203 includes a DATA line that may transmit serial data (e.g., messages, commands, frames, packets, bits, etc.) between the RF module 200 and the RF module 201. The serial bus 203 also includes an S1 line that may indicate when new data is available. The serial bus 203 further includes a CLK line that may transmit a clock signal between the RF module 200 and the RF module 201. The RF device 205 and the RF device 210 may use the clock signal and/or the control the timing of the transmission of data, as discussed above. The S2 line may transmit a signal to the RF device 205 to indicate that the RF device 205 should transmit new data to the RF device 210.

In one embodiment, the RF device 205 may transmit first data to the RF device 210 via the DATA line. The RF device 205 may determine whether new data is available to communicate (e.g., transmit) to the RF device 210, as discussed above. In one embodiment, the RF device 205 may receive the new data while the RF device 205 is in the process of transmitting the first data and/or while the RF device 210 is in the process of receiving the first data, as discussed above. In another embodiment, the RF device 205 may begin transmitting the new data to the RF device 205 without completely transmitting the first data to the RF device 210 and/or before the RF device 210 completely receives first data, as discussed above.

In one embodiment, the RF device 205 may maintain the first signal (transmitted via the S1 line) at a logical high state when the RF device 205 is transmitting new data to the RF device 210 and may change the first signal to a logical low state (e.g., a “0” state) when the RF device 205 completes transmission of the new data. The RF device 210 may use the new data received during a time period before the first signal transitions to the logical low state, as discussed in more detail below.

In another embodiment, the RF device 205 may alternate the first signal between the logical high state and the logical low state each time new data is available for transmission to the RF device 210. The RF device 210 may use the new data received during a time period after the last time the first signal alternated between the logical high state and the logical low state, as discussed in more detail below.

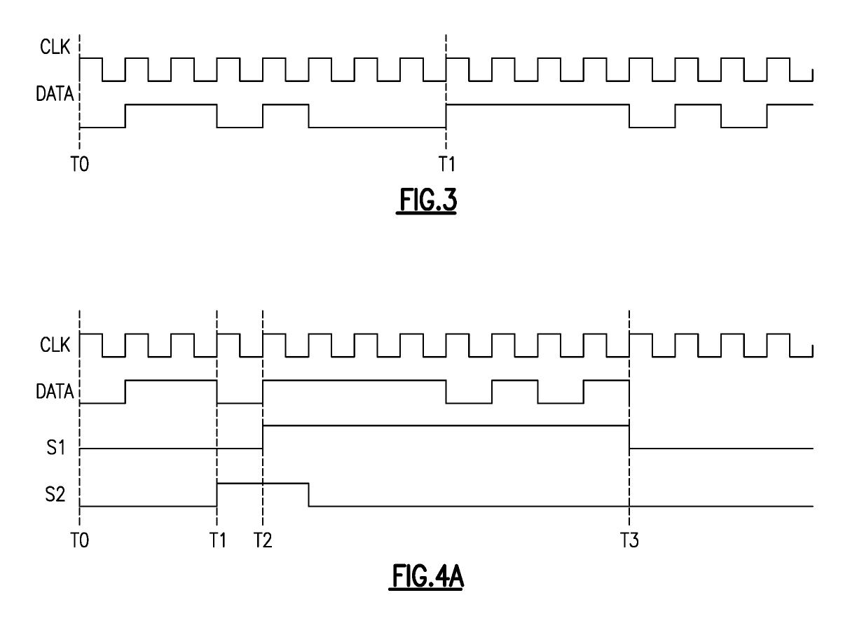

FIG. 3 is a timing diagraming illustrating example data that may be communicated with a serial bus/interface (e.g., an RFFE bus/interface), according to some embodiments of the present disclosure. As discussed above, data may be communicated between devices (e.g., RF devices/modules illustrated in FIGS. 1, 2A and 2B) via the serial bus/interface (e.g., via the DATA line). For example, a master device may transmit data to a slave device. In another example, a slave device may transmit data to a master device. In a further example, a slave device may transmit data to a slave device. The serial bus/interface may include a CLK line (used to transmit/receive a clock or CLK signal) and a DATA line (used to transmit/receive the data such as bits, messages, frames, packets, etc.). The clock signal may be used to control the timing of the serial bus/interface. For example, the DATA line may be synchronized with the clock signal.

As illustrated in FIG. 3, a first device (e.g., a transmitting device) may begin transmitting first data to a second device (e.g., a receiving device) using the DATA line of the serial bus/interface at time T0. As discussed above, the first data may be included in a packet, frame, message, etc. The first device may begin transmitting new data to the second device using the DATA line at time T1. As illustrated in FIG. 3, the first device may take eight clock cycles to completely transmit the first data to the second device. The first device may also take another eight cycles to complete transmit the new data to the second device. Thus, the total time for the first device to transmit the first data and the new data (and for the second device to receive the first data and the new data) is sixteen clock cycles.

As discussed above, the first device may receive the new data to transmit to the second device between time T0 and T1 (e.g., before the first device completely transmits the first data). However, as illustrated in FIG. 3, the first device may not be able to transmit the new data until the first data is completely transmitted to the second device. With increasing complexity in modern wireless communication devices and with users demanding ever increased speed, it may be useful to decrease the latency (e.g., delay) in communicating data (e.g., the new data) to the second device.

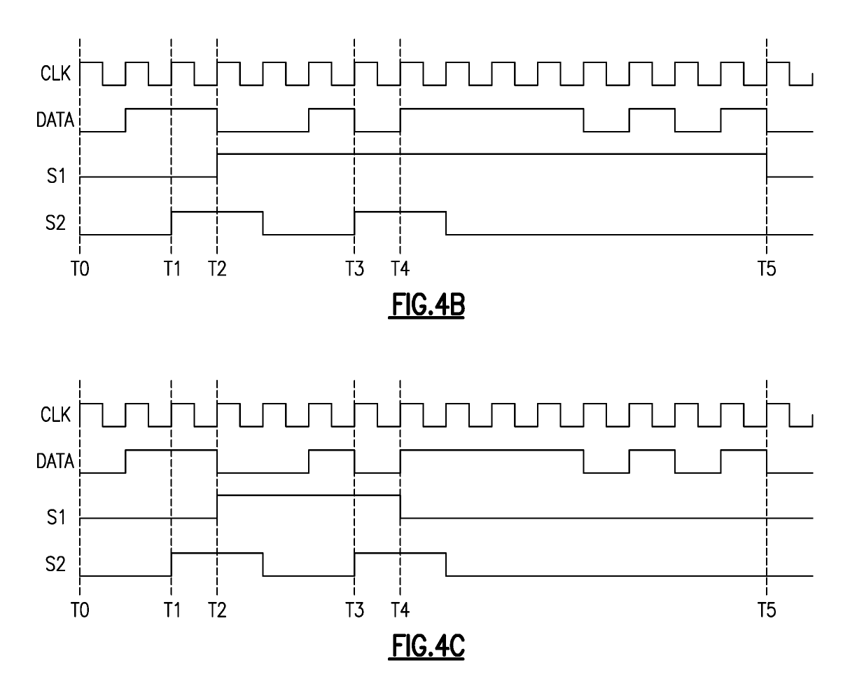

FIG. 4A is a timing diagraming illustrating example data that may be communicated with a serial bus/interface (e.g., an RFFE bus/interface), according to some embodiments of the present disclosure. As discussed above, data may be communicated between devices (e.g., RF devices/modules illustrated in FIGS. 1, 2A and 2B) via the serial bus/interface. The serial bus/interface may include a CLK line (used to transmit/receive a clock or CLK signal), a DATA line (used to transmit/receive the data such as bits, messages, frames, packets, etc.), a S1 line (used to transmit a first signal to a receiving device to indicate that new data is available), and a S2 line (used to transmit a second signal to a transmitting device to indicate that the transmitting device should transmit new data to the receiving device). The clock signal may be used to control the timing of the serial bus/interface.

As illustrated in FIG. 4A, a first device (e.g., the transmitting device) may begin transmitting first data to a second device (e.g., the receiving device) using the DATA line of the serial bus/interface at time T0. As discussed above, the first data may be included in a packet, frame, message, etc. The first device may determine that there is new data available to transmit to the second device at time T1. For example, the second signal transmitted on the S2 line may transition from a logical low state to a logical high state indicating to the first device that there is new data available to transmit to the second device.

At time T2, the first device may transmit a first signal to the second device using the S1 line to indicate that the first device is beginning to transmit the new data to the second device. The first device may also begin transmitting the new data to the second device using the DATA line at time T1. In other embodiments, the first device may transmit the new data to the second device using the data line after time T2. For example, the first device may transmit the new data to the second device after one or more clock cycles have elapsed after the time T2.

As discussed above, it may take the first device eight clock cycles to completely transmit the first data (e.g., to transmit a frame, message, packets, etc., including the first data). However, as illustrated in FIG. 4A, the first device may stop transmitting the first data (e.g., may abort the transmission of the first data) and may begin transmitting the new data without completely transmitting the first data. The first signal (transmitted via the S1 line) may allow the first device to inform the second device that the new data is being transmitted to the second device without completely transmitting the first data. The first signal may allow the second device to discard (e.g., disregard, throw away, ignore, etc.) data that was previously transmitted.

As illustrated in FIG. 4A, instead of taking sixteen cycles to completely transmit the first data and the new data to the second device, the first device may take a total of twelve cycles to transmit part of the first data, halt transmission of the first data (e.g., abort transmission of the first data), and transmit the new data to the second device. This may allow the first device and the second device to reduce the latency (e.g., delay) when communicating data between the first device and the second device via the serial bus/interface.

FIG. 4B is a timing diagraming illustrating an example data that may be communicated with a serial bus/interface (e.g., an RFFE bus/interface), according to some embodiments of the present disclosure. As discussed above, data may be communicated between devices (e.g., RF devices/modules illustrated in FIGS. 1, 2A and 2B) via the serial bus/interface. The serial bus/interface may include a CLK line (used to transmit/receive a clock or CLK signal), a DATA line (used to transmit/receive the data such as bits, messages, frames, packets, etc.), a S1 line (used to transmit a first signal to a receiving device to indicate that new data is available), and a S2 line (used to transmit a second signal to a transmitting device to indicate that the transmitting device should transmit new data to the receiving device). The clock signal may be used to control the timing of the serial bus/interface.

As illustrated in FIG. 4B, a first device (e.g., the transmitting device) may begin transmitting first data to a second device (e.g., the receiving device) using the DATA line of the serial bus/interface at time T0. As discussed above, the first data may be included in a packet, frame, message, etc. The first device may determine that there is new data available to transmit to the second device at time T1. For example, the second signal transmitted on the S2 line may transition from a logical low state to a logical high state indicating to the first device that there is new data available to transmit to the second device. At time T2, the first device may transmit a first signal to the second device using the S1 line to indicate that the first device is beginning to transmit the new data to the second device. The first device may also begin transmitting the new data to the second device using the DATA line at time T1. In other embodiments, the first device may transmit the new data to the second device using the data line after time T2, as discussed above.

The first device may determine that there is additional new data available to transmit to the second device at time T3. For example, the second signal transmitted on the S2 line may transition from a logical low state to a logical high state indicating to the first device that there is additional new data available to transmit to the second device. At time T4, the first device may transmit a first signal to the second device using the S1 line to indicate that the first device is beginning to transmit the additional new data to the second device. The first device may also begin transmitting the additional new data to the second device using the DATA line at time T4. In other embodiments, the first device may transmit the additional new data to the second device using the data line after time T2, as discussed above.

As discussed above, it may take the first device eight clock cycles to completely transmit each of the first data and the new data. However, as illustrated in FIG. 4A, the first device may stop transmitting the first data and the new data (e.g., may abort the transmission of the first data new data) and may begin transmitting the additional new data without completely transmitting the first data and the new data. The first signal (transmitted via the S1 line) may allow the first device to inform the second device that the additional new data is being transmitted to the second device without completely transmitting the first data and the new data. The first signal may allow the second device to discard (e.g., disregard, throw away, ignore, etc.) data that was previously transmitted. For example, the second device may discard the portions of the first data and the new data that were transmitted by the first device.

As illustrated in FIG. 4B, the first device may maintain the first signal (transmitted via the S1 line) in a logical high state when there is new data to transmit to the second device. For example, the first signal transitions to a logical high state at time T2 and remains in the logical high state until time T5. The second device (e.g., the receiving device) may determine that the first signal has transitioned to the logical low state at time T5 and may process and/or analyze the data received eight clock cycles before the time T5. The second device may discard all data received more than eight clock cycles before the time T5. For example, the second device may process and/or analyze data received during the time period of eight cycles before the time T5.

Thus, instead of taking twenty-four clock cycles to completely transmit the first data, the new data, and the additional new data to the second device, the first device may take a total of fifteen clock cycles to transmit part of the first data, halt transmission of the first data, transmit part of the new data, halt transmission of the new data, and transmit the additional new data to the second device. This may allow the first device and the second device to reduce the latency (e.g., delay) when communicating data between the first device and the second device via the serial bus/interface.

FIG. 4C is a timing diagraming illustrating an example data that may be communicated with a serial bus/interface (e.g., an RFFE bus/interface), according to some embodiments of the present disclosure. As discussed above, data may be communicated between devices (e.g., RF devices/modules illustrated in FIGS. 1, 2A and 2B) via the serial bus/interface. The serial bus/interface may include a CLK line (used to transmit/receive a clock or CLK signal), a DATA line (used to transmit/receive the data such as bits, messages, frames, packets, etc.), a S1 line (used to transmit a first signal to a receiving device to indicate that new data is available), and a S2 line (used to transmit a second signal to a transmitting device to indicate that the transmitting device should transmit new data to the receiving device). The clock signal may be used to control the timing of the serial bus/interface.

As illustrated in FIG. 4C, a first device (e.g., the transmitting device) may begin transmitting first data to a second device (e.g., the receiving device) using the DATA line of the serial bus/interface at time T0. As discussed above, the first data may be included in a packet, frame, message, etc. The first device may determine that there is new data available to transmit to the second device at time T1. For example, the second signal transmitted on the S2 line may transition from a logical low state to a logical high state indicating to the first device that there is new data available to transmit to the second device. At time T2, the first device may transmit a first signal having a logical high state (e.g., the first signal may transition between a logical low state to a logical high state) to the second device using the S1 line to indicate that the first device is beginning to transmit the new data to the second device. The first device may also begin transmitting the new data to the second device using the DATA line at time T1. In other embodiments, the first device may transmit the new data to the second device using the data line after time T2, as discussed above.

The first device may determine that there is additional new data available to transmit to the second device at time T3. For example, the second signal transmitted on the S2 line may transition from a logical low state to a logical high state indicating to the first device that there is additional new data available to transmit to the second device. At time T4, the first device may transmit a first signal having a logical low state (e.g., the first signal may transition between a logical high state to a logical low state) to the second device using the S1 line to indicate that the first device is beginning to transmit the additional new data to the second device. The first device may also begin transmitting the additional new data to the second device using the DATA line at time T4. In other embodiments, the first device may transmit the additional new data to the second device using the data line after time T2, as discussed above.

As discussed above, it may take the first device eight clock cycles to completely transmit each of the first data and the new data. However, as illustrated in FIG. 4A, the first device may stop transmitting the first data and the new data (e.g., may abort the transmission of the first data new data) and may begin transmitting the additional new data without completely transmitting the first data and the new data. The first signal (transmitted via the S1 line) may allow the first device to inform the second device that the additional new data is being transmitted to the second device without completely transmitting the first data and the new data. The first signal may allow the second device to discard (e.g., disregard, throw away, ignore, etc.) data that was previously transmitted. For example, the second device may discard the portions of the first data and the new data that were transmitted by the first device.

As illustrated in FIG. 4C, the first device may transition the first signal (transmitted via the S1 line) between the logical high state and the logical low state each time there is new data to transmit to the second device. For example, the first signal transitions from the logical low state to the logical high state at time T2 when the first device begins to transmit the new data. The first signal transitions from the logical high state to the logical low state at time T4 when the first device begins to transmit the additional new data. The second device (e.g., the receiving device) may determine the last time the first signal transitioned between states (e.g., the logical high state and the logical low state) was at time T4. The second device may discard all data received before time T4 and may process and/or analyze the data received eight cycles after the time T4. For example, the second device may process and/or analyze the data received during the time period of eight cycles after the time T4.

Thus, instead of taking twenty-four clock cycles to completely transmit the first data, the new data, and the additional new data to the second device, the first device may take a total of fifteen clock cycles to transmit part of the first data, halt transmission of the first data, transmit part of the new data, halt transmission of the new data, and transmit the additional new data to the second device. This may allow the first device and the second device to reduce the latency (e.g., delay) when communicating data between the first device and the second device via the serial bus/interface.

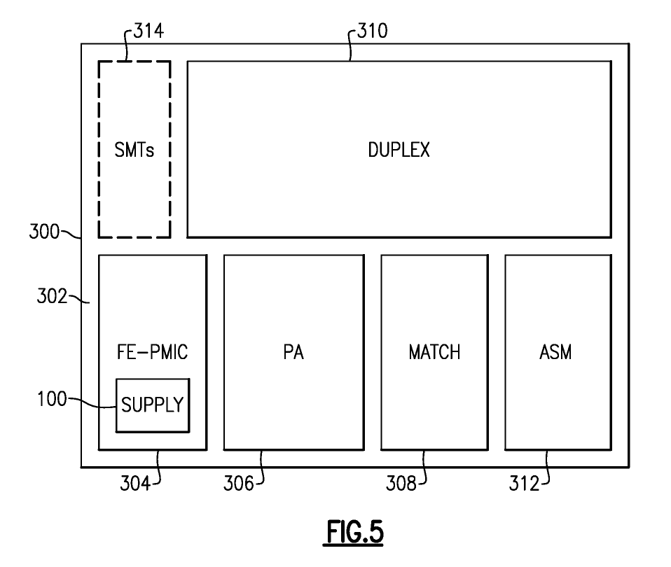

FIG. 5 shows that in some embodiments, some or all of the devices and/or serial buses/interfaces having one or more features as described herein may be implemented in a module. Such a module may be, for example, a front-end module (FEM). In the example of FIG. 5, a radio frequency (RF) module 300 can include a packaging substrate 302, and a number of components may be mounted on such a packaging substrate. For example, a front-end power management integrated circuit (FE-PMIC) component 304, a power amplifier assembly 306, a match component 308, and a duplexer assembly 310 may be mounted and/or implemented on and/or within the packaging substrate 302. The FE-PMIC component 304 includes a supply 100 which may be a power supply (e.g., a battery, a voltage/power source) and/or may be coupled to a power supply. Other components such as a number of surface mount technology (SMT) devices 314 and an antenna switch module (ASM) 312 can also be mounted on the packaging substrate 302. Although all of the various components are depicted as being laid out on the packaging substrate 302, it will be understood that some component(s) may be implemented over other component(s). In some embodiments, the components of the RF module 300 and one or more serial buses/interfaces used by the components of the RF module 300 may implement and/or perform one or more features as described herein.

In some implementations, a device and/or a circuit having one or more features described herein may be included in a device such as a wireless device. Such a device and/or a circuit may be implemented directly in the wireless device, in a modular form as described herein, or in some combination thereof. In some embodiments, such a wireless device can include, for example, a cellular phone, a smart-phone, a hand-held wireless device with or without phone functionality, a wireless tablet, etc.

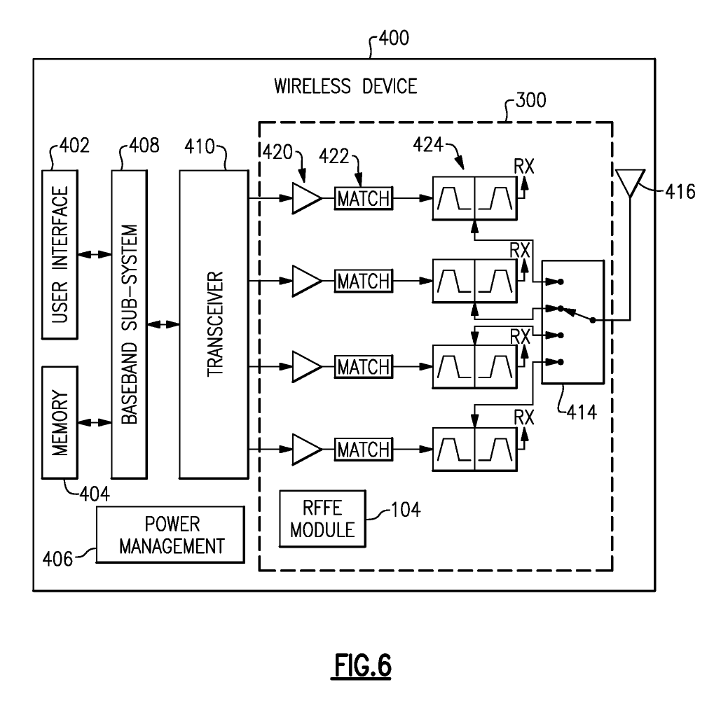

FIG. 6 depicts an example wireless device 400 having one or more advantageous features described herein. In the context of a module having one or more features as described herein, such a module may be generally depicted by a RF module 300 (illustrated by the dashed box), and may be implemented as, for example, a front-end module (FEM). Such a module may include a RFFE module 104 having one or more features as described herein. The components of the RF module 300 and/or serial buses/interfaces of the RF module 300 may also have one or more features as described herein.

Referring to FIG. 6, power amplifiers (PAs) 420 can receive their respective RF signals from a transceiver 410 that may be configured and operated in known manners to generate RF signals to be amplified and transmitted, and to process received signals. The transceiver 410 is shown to interact with a baseband sub-system 408 that is configured to provide conversion between data and/or voice signals suitable for a user and RF signals suitable for the transceiver 410. The transceiver 410 can also be in communication with a power management component 406 that is configured to manage power for the operation of the wireless device 400. Such power management can also control operations of the baseband sub-system 408 and the RF module 300.

The baseband sub-system 408 is shown to be connected to a user interface 402 to facilitate various input and output of voice and/or data provided to and received from the user. The baseband sub-system 408 can also be connected to a memory 404 that is configured to store data and/or instructions to facilitate the operation of the wireless device, and/or to provide storage of information for the user.

In the example wireless device 400, outputs of the PAs 420 are shown to be matched (via respective match circuits 422) and routed to their respective duplexers 420. Such amplified and filtered signals may be routed to an antenna 416 through an antenna switch 414 for transmission. In some embodiments, the duplexers 420 can allow transmit and receive operations to be performed simultaneously using a common antenna (e.g., 416). In FIG. 6, received signals are shown to be routed to “Rx” paths (not shown) that can include, for example, a low-noise amplifier (LNA).

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

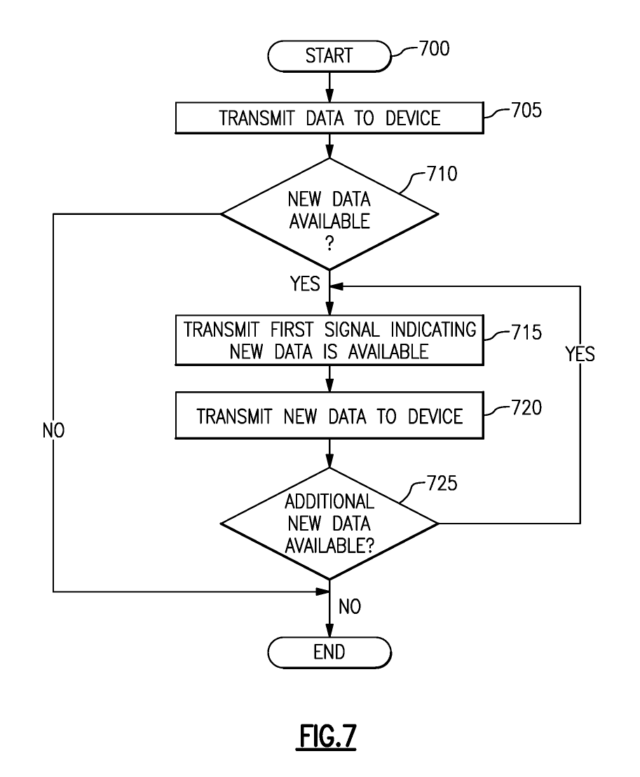

FIG. 7 is a flow diagram illustrating a process 700 for transmitting data via a serial bus, according to some embodiments of the present disclosure. The process 700 may be performed by processing logic that comprises hardware (e.g., circuitry, dedicated logic, programmable logic, microcode, etc.), software (e.g., instructions run on a processor to perform hardware simulation), or a combination thereof. In one embodiment, process 700 may be performed by an RF module and/or RF device, as illustrated in FIGS. 1, 2A, and 2B. In addition, the process 700 could alternatively be represented as a series of interrelated states via a state diagram or events.

The process 700 begins at block 705 where data is transmitted (via a DATA line) to a device (e.g., an RF device and/or RF module). At block 710, the process 700 determines whether new data is available to transmit to the device. For example, referring to FIGS. 2A and 2B, the process 700 may determine whether new data is available based on a signal transmitted via the S2 line, as discussed above. If there is no new data available, the process 700 ends. If there is new data available, the process 700 proceeds to block 715 where the process 700 transmits a first signal to the device indicating that new data is available. For example, referring to FIGS. 2A and 2B, the process 700 may transmit a signal via the S1 line. At block 720, the process 700 transmit the new data to the device.

At block 725, the process 700 determines whether additional new data is available to transmit to the device. For example, referring to FIGS. 2A and 2B, the process 700 may determine whether additional new data is available based on a signal transmitted via the S2 line, as discussed above. If there is no new data available, the process 700 ends. If there is new data available, the process 700 proceeds to block 715.

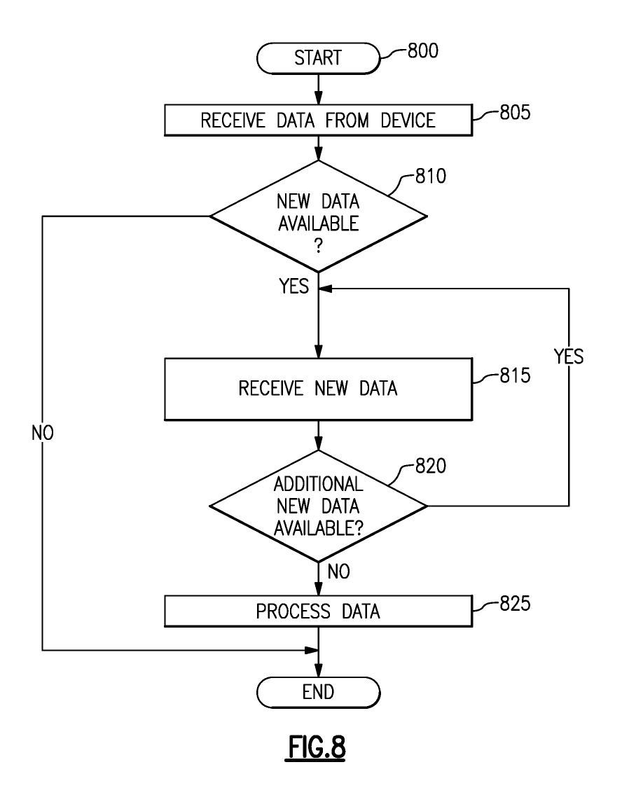

FIG. 8 is a flow diagram illustrating a process 800 for receiving data via a serial bus, according to some embodiments of the present disclosure. The process 800 may be performed by processing logic that comprises hardware (e.g., circuitry, dedicated logic, programmable logic, microcode, etc.), software (e.g., instructions run on a processor to perform hardware simulation), or a combination thereof. In one embodiment, process 800 may be performed by an RF module and/or RF device, as illustrated in FIGS. 1, 2A, and 2B. In addition, the process 800 could alternatively be represented as a series of interrelated states via a state diagram or events.

The process 800 begins with receiving data (via a DATA line) from a device (e.g., an RF device, an RF module, etc.) at block 805. At block 810, the process 800 determines whether new data is available. For example, referring to FIGS. 2A and 2B, the process 800 may determine whether a signal is transmitted via the S1 line. If there is no new data available, the process 800 ends. If there is new data available, the process 800 receives the new data at block 815. At block 820, the process 800 determines whether there is additional new data available. For example, referring to FIGS. 2A and 2B, the process 800 may determine whether a signal is transmitted via the S1 line. If there is no new data available, the process 800 may process and/or analyze the data at block 825. If there is additional new data available, the process 800 proceeds to block 815.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts may be performed as a single step and/or phase. Also, certain steps and/or phases may be broken into additional sub-components to be performed separately. In some instances, the order of the steps and/or phases may be rearranged and certain steps and/or phases may be omitted entirely. Also, the methods described herein are to be understood to be open-ended, such that additional steps and/or phases to those shown and described herein may also be performed.

Although various embodiments and examples are disclosed above, inventive subject matter extends beyond the specifically disclosed embodiments to other alternative embodiments and/or uses and to modifications and equivalents thereof. Thus, the scope of the claims that may arise from this disclosure is not limited by any of the particular embodiments described above. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Some aspects of the systems and methods described herein may advantageously be implemented using, for example, computer software, hardware, firmware, or any combination of computer software, hardware, and firmware. Computer software may comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that may be implemented using software to be executed on a general purpose computer may also be implemented using a different combination of hardware, software, or firmware. For example, such a module may be implemented completely in hardware using a combination of integrated circuits. Alternatively or additionally, such a feature or function may be implemented completely or partially using specialized computers designed to perform the particular functions described herein rather than by general purpose computers.

Multiple distributed computing devices may be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that may direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations. Furthermore, the terms “first,” “second,” “third,” “fourth,” etc., as used herein are meant as labels to distinguish among different elements and may not necessarily have an ordinal meaning according to their numerical designation.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein may be applied to other methods and systems, and are not limited to the methods and systems described above, and elements and acts of the various embodiments described above may be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A radio-frequency (RF) module comprising:
a serial data line configured to communicate data serially;
a first signal line configured to indicate that new data is available for transmission via the serial data line; and
a first device coupled to the serial data line and the first signal line, the first device configured to transmit first data to a second device via the serial data line, transmit a first signal via the first signal line indicating to the second device that the new data is available, and transmit the new data to the second device via the serial data line.

2. The radio-frequency module of claim 1 wherein the new data is received during transmission of the first data.

3. The radio-frequency module of claim 1 wherein the new data is transmitted prior to completion of transmission the first data.

4. The radio-frequency module of claim 1 wherein the first data is included in a first frame.

5. The radio-frequency module of claim 4 wherein the new data is transmitted without completing transmission of the first frame.

6. The radio-frequency module of claim 1 wherein the first device is further configured to determine that the new data is available for transmission via the serial data line.

7. The radio-frequency module of claim 6 further comprising a second signal line configured receive a second signal indicating to the first device that the new data is available for transmission to the second device via the serial data line.

8. The radio-frequency module of claim 7 wherein the first device is determines that the new data is available for transmission based on the second signal.

9. The radio-frequency module of claim 1 wherein the first device is further configured to alternate the first signal between a first state and a second state each time new data is available for transmission.

10. The RF module of claim 1 wherein the first device is configured to maintain the first signal at a first state when new data is available for transmission.

11. The radio-frequency module of claim 1 further comprising the second device.

12. The radio-frequency module of claim 1 wherein the second device is separate from the RF module.

13. The radio-frequency module of claim 1 further comprising a clock line configured to transmit a clock signal.

14. The radio-frequency module of claim 13 wherein the first device is configured to transmit the first data based on the clock signal.

15. The radio-frequency module of claim 13 wherein the first device is configured to transmit the new data based on the clock signal.

16. A radio-frequency (RF) module comprising:
a serial data line configured to communicate data serially;
a first signal line configured to indicate that new data is available for receiving via the serial data line; and
a first device coupled to the serial data line and the first signal line, the first device configured to receive first data from a second device via the serial data line, receive a first signal via the first signal line indicating to the first device that the new data is available, and receive the new data from the second device via the serial data line.

17-29. (canceled)

30. A method comprising:
transmitting first data to a device via a serial data line;
determining that new data is available to transmit to the device;
transmit a first signal via a first signal indicating to the device that the new data is available; and
transmitting the new data to the device via the serial data line.

31. (canceled)

32. The method of claim 30 wherein the new data is received prior to completion of transmission the first data.

33-37. (canceled)

38. A method comprising:
receiving first data from a device via a serial data line;
receiving a first signal via a first signal line indicating that new data is available; and
receiving the new data from the device via the serial data line.

39. (canceled)

40. The method of claim 38 wherein the new data is received prior to completion of receipt the first data.

41-50. (canceled)
